(19) United States
(12) Patent Application Publication
(10) Pub. No.: US 2012/0220292 A1
(43) Pub. Date: Aug. 30, 2012

(54) Preventing Dropped Calls Using Voice Services Over Adaptive Multi-User Channels on One Slot (Vamos) Mode

(75) Inventors: Zhi-Zhong YU, Reading Berkshire (GB); Divaydeep Sikri, Farnborough (GB)

(73) Assignee: QUALCOMM INCORPORATED, San Diego, CA (US)

(21) Appl. No.: 13/403,830

(22) Filed: Feb. 23, 2012

Related U.S. Application Data
(60) Provisional application No. 61/446,401, filed on Feb. 24, 2011.

(51) Int. Cl. H04W 24/04

(52) U.S. Cl. 455/424

(57) ABSTRACT

Embodiments of the present invention include devices, systems and methods for prevention of dropped calls. For example, a method for preventing dropped voice calls can be performed by a base station. Multiple reports are received from multiple wireless communication devices. A first wireless communication device having a poor received signal is identified using the reports. A sub-channel power imbalance ratio is adjusted so that the base station gives favorable power imbalance to the first wireless communication device over a second wireless communication device. The second wireless communication device is paired with the first wireless communication device. Adjusting the sub-channel power imbalance ratio prevents a voice call by the first wireless communication device from being dropped that would otherwise be dropped. Other aspects, embodiments and features are also claimed and described.

### RELATED APPLICATIONS AND PRIORITY CLAIM

This application is related to and claims priority from U.S. Provisional Patent Application Ser. No. 61/446,401, filed Feb. 24, 2011, for “PREVENTING DROPPED CALLS USING VOICE SERVICES OVER ADAPTIVE MULTI-USER CHANNELS ON ONE SLOT (VAMOS) MODE,” which is incorporated herein by reference.

### TECHNICAL FIELD

Embodiments of the present invention relate generally to communication systems. More specifically, embodiments of the present invention relate to systems and methods for preventing dropped calls using voice services over adaptive multi-user channels on one slot (VAMOS) mode. Embodiments of the present invention may be utilized within wireless communication systems, devices, methods, and articles of manufacture for communication components.

### BACKGROUND

Wireless communication systems have become an important means by which many people worldwide have come to communicate. A wireless communication system may provide communication for a number of subscriber stations, each of which may be serviced by a base station.

New subscriber stations are continuously being released to the public. These new subscriber stations boast more features and increased reliability. However, older subscriber stations continue to be used by consumers. These older subscriber stations may be collectively referred to as legacy devices. As updates are made to the base stations, the operation of these legacy devices may be considered, as the legacy devices are still being actively used by paying consumers of the wireless communication systems.

One major concern for users of subscriber stations is the frequency of dropped calls. Dropped calls reduce the satisfaction rate of wireless communication providers. Benefits may be realized by reducing the frequency of dropped calls for subscriber stations, including legacy devices.

### SUMMARY OF SOME EXAMPLE EMBODIMENTS

A method for preventing bad user experience and dropped voice calls is described. The method is performed by an access point. A first wireless communication device having a poor received signal is identified using multiple reports received from multiple wireless communication devices. A sub-channel power imbalance ratio is adjusted so that the access point gives a favorable power imbalance to the first wireless communication device over a second wireless communication device. The second wireless communication device is paired with the first wireless communication device. Adjusting the sub-channel power imbalance ratio prevents a voice call by the first wireless communication device from being dropped that would otherwise be dropped.

The access point may be configured to use voice services over adaptive multi-user channels on one slot. The voice services over adaptive multi-user channels on one slot may enable the access point to support up to four transmit channel/half rate channels along with their associated control channels in one slot. The voice services over adaptive multi-user channels on one slot may use adaptive quadrature phase shift keying. The reports may be slow associated control channel reports.

The first wireless communication device may be a legacy wireless communication device or a downlink advanced receiver performance wireless communication device. The first wireless communication device may be allowed to operate in voice services over adaptive multi-user channels on one slot mode. The second wireless communication device may miss one burst during the adjustment of the sub-channel power imbalance ratio.

The access point giving favorable power imbalance to the first wireless communication device may include giving occasional and random favorable power imbalance to the first wireless communication device. Adjusting a sub-channel power imbalance ratio may give Gaussian minimum shift keying to the first wireless communication device. Adjusting a sub-channel power imbalance ratio may instead give favorable adaptive quadrature shift keying to the first wireless communication device.

An apparatus for preventing bad user experience and dropped voice calls is also described. The apparatus includes a processor, memory in electronic communication with the processor and instructions stored in the memory. The instructions are executable by the processor to identify a first wireless communication device having a poor received signal using multiple reports received from multiple wireless communication devices. The instructions are also executable by the processor to adjust a sub-channel power imbalance ratio so that the apparatus gives a favorable power imbalance to the first wireless communication device over a second wireless communication device. The second wireless communication device is paired with the first wireless communication device. Adjusting the sub-channel power imbalance ratio prevents a voice call by the first wireless communication device from being dropped that would otherwise be dropped.

The apparatus may be a base station configured to use voice services over adaptive multi-user channels on one slot.

A wireless device for preventing bad user experience dropped voice calls is described. The wireless device includes means for identifying a first wireless communication device having a poor received signal using multiple reports received from multiple wireless communication devices. The wireless device also includes means for adjusting a sub-channel power imbalance ratio so that the wireless device gives a favorable power imbalance to the first wireless communication device over a second wireless communication device. The second wireless communication device is paired with the first wireless communication device. Adjusting the sub-channel power imbalance ratio prevents a voice call by the first wireless communication device from being dropped that would otherwise be dropped.

A computer-program product for preventing bad user experience and dropped voice calls is also described. The computer-program product includes a non-transitory computer-readable medium having instructions thereon. The instructions include code for causing an access point to identify a first wireless communication device having a poor received signal using multiple reports received from multiple wireless communication devices. The instructions also include code for causing the access point to adjust a sub-channel power imbalance ratio so that the base station gives a favorable power imbalance to the first wireless communication device over a second wireless communication device. The second wireless communication device is paired with the first wireless communication device. Adjusting the sub-channel power imbalance ratio prevents a voice call by the first wireless communication device from being dropped that would otherwise be dropped.

An apparatus configured for preventing bad user experience and dropped voice calls is described. The apparatus includes a processor, memory in electronic communication with the processor and instructions stored in the memory. The instructions are executable by the processor to discern changes in adaptive quadrature phase shift keying/sub-channel power imbalance ratio implemented by a base station. The instructions are also executable by the processor to perform adaptive burst processing according to the changes.

The apparatus may be a wireless communication device. The adaptive burst processing can result in a bit error rate and/or frame error rate that prevents a phone call from being dropped or from providing unintelligible voice call quality for end users.

A wireless device for preventing bad user experience and dropped voice calls is also described. The wireless device includes means for discerning changes in adaptive quadrature phase shift keying/sub-channel power imbalance ratio implemented by a base station. The wireless device also includes means for performing adaptive burst processing according to the changes. The adaptive burst processing can result in a bit error rate and/or frame error rate that prevents a phone call from being dropped or from providing unintelligible voice call quality for end users.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 shows an example of a wireless communication system in which embodiments of the present invention disclosed herein may be utilized according to some embodiments of the present invention;

FIG. 2 shows a block diagram of a transmitter and a receiver in a wireless communication system according to some embodiments of the present invention;

FIG. 3 shows a block diagram of a design of a receiver unit and demodulator at a receiver according to some embodiments of the present invention;

FIG. 4 shows example frame and burst formats in GSM according to some embodiments of the present invention;

FIG. 5 shows an example spectrum in a GSM system according to some embodiments of the present invention;

FIG. 6 illustrates an example of a wireless device that includes transmit circuitry (including a power amplifier), receive circuitry, a power controller, a decode processor, a processing unit for use in processing signals and memory according to some embodiments of the present invention;

FIG. 7 illustrates an example of a transmitter structure and/or process according to some embodiments of the present invention;

FIG. 8 is a block diagram illustrating some of the elements of the GERAN stack that are used to support voice services over adaptive multi-user channels on one slot (VAMOS) according to some embodiments of the present invention;

FIG. 9 is a block diagram illustrating how, in some embodiments, different numbers of users may be served in a timeslot using voice services over adaptive multi-user channels on one slot (VAMOS) according to some embodiments of the present invention;

FIG. 10 is a block diagram illustrating one embodiment of the voice services over adaptive multi-user channels on one slot (VAMOS) downlink physical layer functionality of a base station according to some embodiments of the present invention;

FIG. 11 is a flow diagram of a method for preventing dropped voice calls according to some embodiments of the present invention;

FIG. 12 illustrates two adaptive quadrature phase shift keying (AQPSK) constellations according to some embodiments of the present invention;

FIG. 13 illustrates certain components that may be included within a base station according to some embodiments of the present invention; and

FIG. 14 illustrates certain components that may be included within a wireless communication device according to some embodiments of the present invention.

### DETAILED DESCRIPTION OF EXEMPLARY & ALTERNATIVE EMBODIMENTS

More and more people are using wireless communication devices, such as, mobile phones, not only for voice but also for data communications. Telecommunications networks are being placed under increasing strain, both due to increasing bandwidth requirements of smartphones and mobile computers, and the increasing numbers devices and programs that seek access to the networks. For example, many applications running on smartphones periodically access the network to check for updates. While each access itself only consumes a relatively small amount of bandwidth, large numbers of devices running lots of applications can place a significant load on networks, and signaling and control channels in particular. The increasing prevalence of machine type communication (MTC) devices (e.g., machine-to-machine (M2M)) can similarly increase the demands placed upon network resources.

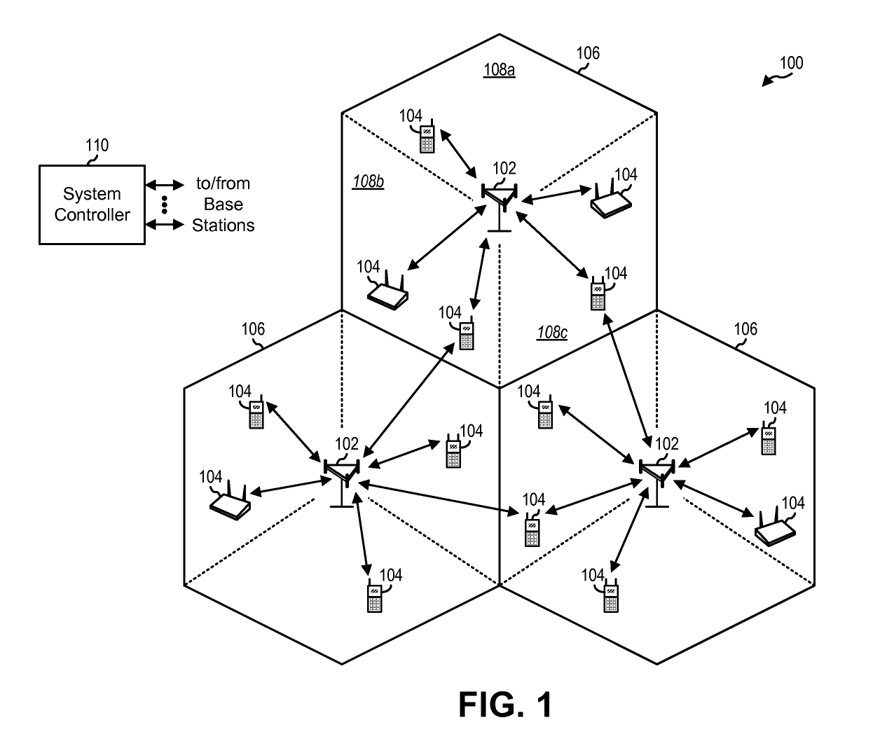

FIG. 1 shows an example of a wireless communication system 100 in which embodiments of the present invention disclosed herein may be utilized. The wireless communication system 100 includes multiple base stations 102 and multiple wireless communication devices 104. Each base station 102 provides communication coverage for a particular geographic area 106. The term “cell” can refer to a base station 102 and/or its coverage area 106 depending on the context in which the term is used.

The terms “wireless communication device” and “base station” utilized in this application can generally refer to an array of components. For example, as used herein, the term “wireless communication device” refers to an electronic device that may be used for voice and/or data communication over a wireless communication system. Examples of wireless communication devices 104 include cellular phones, personal digital assistants (PDAs), handheld devices, wireless modems, laptop computers and personal computers. A wireless communication device 104 may alternatively be referred to as an access terminal, a mobile terminal, a mobile station, a remote station, a user terminal, a terminal, a subscriber unit, a subscriber station, a mobile device, a wireless device, user equipment (UE), or some other similar terminology. Also, the term “base station” can refer to a wireless communication station that is installed at a fixed location and used to communicate with wireless communication devices 104. A base station 102 may alternatively be referred to as an access point (including nano-, pico- and femto-cells), a Node B, an evolved Node B, a Home Node B or some other similar terminology.

To improve system capacity, a base station coverage area 106 may be partitioned into plural smaller areas, e.g., three smaller areas 108a, 108b, and 108c. Each smaller area 108a, 108b, 108c may be served by a respective base transceiver station (BTS). The term “sector” can refer to a BTS and/or its coverage area 108 depending on the context in which the term is used. For a sectorized cell, the BTSs for all sectors of that cell are typically co-located within the base station 102 for the cell.

Wireless communication devices 104 are typically dispersed throughout the wireless communication system 100. A wireless communication device 104 may communicate with one or more base stations 102 on the downlink and/or uplink at any given moment. The downlink (or forward link) refers to the communication link from a base station 102 to a wireless communication device 104, and the uplink (or reverse link) refers to the communication link from a wireless communication device 104 to a base station 102. Uplink and downlink may refer to the communication link or to the carriers used for the communication link.

For a centralized architecture, a system controller 110 may couple to the base stations 102 and provide coordination and control for the base stations 102. The system controller 110 may be a single network entity or a collection of network entities. As another example, for a distributed architecture, base stations 102 may communicate with one another as needed.

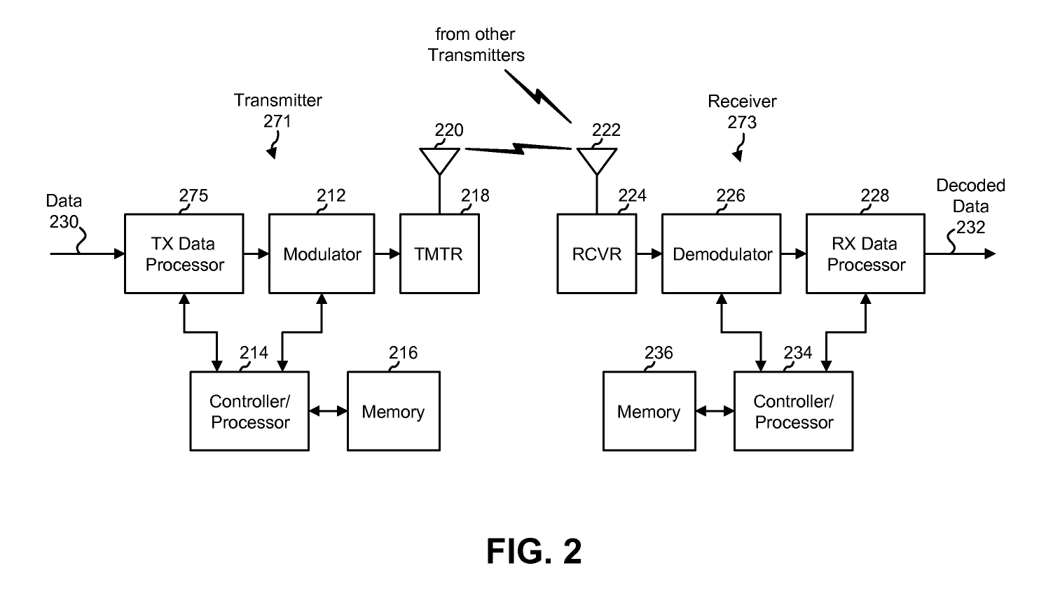

FIG. 2 shows a block diagram of a transmitter 271 and a receiver 273 in a wireless communication system 100 according to some embodiments of the present invention. For the downlink, the transmitter 271 may be part of a base station 102 and the receiver 273 may be part of a wireless communication device 104. For the uplink, the transmitter 271 may be part of a wireless communication device 104 and the receiver 273 may be part of a base station 102.

At the transmitter 271, a transmit (TX) data processor 275 receives and processes (e.g., formats, encodes, and interleaves) data 230 and provides coded data. A modulator 212 performs modulation on the coded data and provides a modulated signal. The modulator 212 may perform Gaussian minimum shift keying (GMSK) for GSM, 8-ary phase shift keying (8-PSK) for Enhanced Data rates for Global Evolution (EDGE), etc. GMSK is a continuous phase modulation protocol whereas 8-PSK is a digital modulation protocol. A transmitter unit (TMTR) 218 conditions (e.g., filters, amplifies, and upconverts) the modulated signal and generates an RF modulated signal, which is transmitted via an antenna 220.

At the receiver 273, an antenna 222 receives RF modulated signals from the transmitter 271 and other transmitters. The antenna 222 provides a received RF signal to a receiver unit (RCVR) 224. The receiver unit 224 conditions (e.g., filters, amplifies, and downconverts) the received RF signal, digitizes the conditioned signal, and provides samples. A demodulator 226 processes the samples as described below and provides demodulated data 232. A receive (RX) data processor 228 processes (e.g., deinterleaves and decodes) the demodulated data and provides decoded data. In general, the processing by demodulator 226 and RX data processor 228 is complementary to the processing by the modulator 212 and the TX data processor 275, respectively, at the transmitter 271.

Controllers/processors 214 and 234 direct operation at the transmitter 271 and receiver 273, respectively. Memories 216 and 236 store program codes in the form of computer software and data used by the transmitter 271 and receiver 273, respectively.

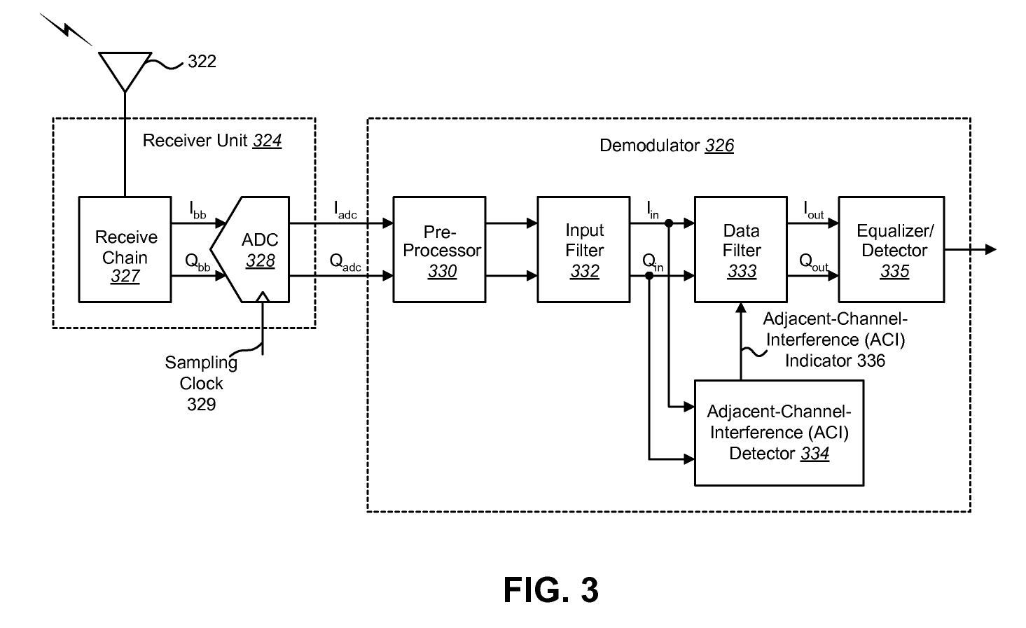

FIG. 3 shows a block diagram of a design of a receiver unit 324 and a demodulator 326 at a receiver 273. Within the receiver unit 324, a receive chain 327 processes the received RF signal and provides I (inphase) and Q (quadrature) baseband signals, which are denoted as I_{bb} and Q_{bb}. The receive chain 327 may perform low noise amplification, analog filtering, quadrature downconversion, etc. as desired or needed. An analog-to-digital converter (ADC) 328 digitalizes the I and Q baseband signals at a sampling rate of f_{adc} from a sampling clock 329 and provides I and Q samples, which are denoted as I_{adc} and Q_{adc}. In general, the ADC sampling rate f_{adc} may be related to the symbol rate f_{sym} by any integer or non-integer factor.

Within the demodulator 326, a pre-processor 330 performs pre-processing on the I and Q samples from the analog-to-digital converter (ADC) 328. For example, the pre-processor 330 may remove direct current (DC) offset, remove frequency offset, etc. An input filter 332 filters the samples from the pre-processor 330 based on a particular frequency response and provides input I and Q samples, which are denoted as Iᵢₙ and Qᵢₙ. The input filter 332 may filter the I and Q samples to suppress images resulting from the sampling by the analog-to-digital converter (ADC) 328 as well as jammers. The input filter 332 may also perform sample rate conversion, e.g., from 24× oversampling down to 2× oversampling. A data filter 333 filters the input I and Q samples from the input filter 332 based on another frequency response and provides output I and Q samples, which are denoted as Iₒᵤₜ and Qₒᵤₜ. The input filter 332 and the data filter 333 may be implemented with finite impulse response (FIR) filters, infinite impulse response (IIR) filters, or filters of other types. The frequency responses of the input filter 332 and the data filter 333 may be selected to achieve good performance. In one design, the frequency response of the input filter 332 is fixed and the frequency response of the data filter 333 is configurable.

An adjacent-channel-interference (ACI) detector 334 receives the input I and Q samples from the input filter 332, detects for adjacent-channel-interference (ACI) in the received RF signal, and provides an adjacent-channel-interference (ACI) indicator 336 to the data filter 333. The adjacent-channel-interference (ACI) indicator 336 may indicate whether or not adjacent-channel-interference (ACI) is present and, if present, whether the adjacent-channel-interference (ACI) is due to the higher RF channel centered at +200 kilohertz (kHz) and/or the lower RF channel centered at −200 kHz. The frequency response of the data filter 333 may be adjusted based on the adjacent-channel-interference (ACI) indicator 336, to achieve desirable performance.

An equalizer/detector 335 receives the output I and Q samples from the data filter 333 and performs equalization, matched filtering, detection and/or other processing on these samples. For example, the equalizer/detector 335 may implement a maximum likelihood sequence estimator (MLSE) that determines a sequence of symbols that is most likely to have been transmitted given a sequence of I and Q samples and a channel estimate.

The Global System for Mobile Communications (GSM) is a widespread standard in cellular, wireless communication. GSM is relatively efficient for standard voice services. However, high-fidelity audio and data services require higher data throughput rates than that for which GSM is optimized. To increase capacity, the General Packet Radio Service (GPRS), EDGE (Enhanced Data rates for GSM Evolution) and UMTS (Universal Mobile Telecommunications System) standards have been adopted in GSM systems. In the GSM/EDGE Radio Access Network (GERAN) specification, GPRS and EGPRS provide data services. The standards for GERAN are maintained by the 3GPP (Third Generation Partnership Project). GERAN is a part of GSM. More specifically, GERAN is the radio part of GSM/EDGE together with the network that joins the base stations 102 (the Ater and Abis interfaces) and the base station controllers (A interfaces, etc.). GERAN represents the core of a GSM network. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM networks typically operate in a number of frequency bands. For example, for uplink communication, GSM-900 commonly uses a radio spectrum in the 890-915 megahertz (MHz) bands (Mobile Station to Base Transceiver Station). For downlink communication, GSM 900 uses 935-960 MHz bands (base station 102 to wireless communication device 104). Furthermore, each frequency band is divided into 200 kHz carrier frequencies providing 124 RF channels spaced at 200 kHz. GSM-1900 uses the 1850-1910 MHz bands for the uplink and 1930-1990 MHz bands for the downlink. Like GSM 900, FDMA divides the spectrum for both uplink and downlink into 200 kHz-wide carrier frequencies. Similarly, GSM-850 uses the 824-849 MHz bands for the uplink and 869-894 MHz bands for the downlink, while GSM-1800 uses the 1710-1785 MHz bands for the uplink and 1805-1880 MHz bands for the downlink.

An example of an existing GSM system is identified in technical specification document 3GPP TS 45.002 V4.8.0 (2003-06) entitled “Technical Specification 3rd Generation Partnership Project; Technical Specification Group GSM/EDGE Radio Access Network; Multiplexing and multiple access on the radio path (Release 4)”, published by the 3rd Generation Partnership Project (3GPP) standards-setting organization.

Each channel in GSM is identified by a specific absolute radio frequency channel (ARFCN). For example, ARFCN 1-124 are assigned to the channels of GSM 900, while ARFCN 512-810 are assigned to the channels of GSM 1900. Similarly, ARFCN 128-251 are assigned to the channels of GSM 850, while ARFCN 512-885 are assigned to the channels of GSM 1800. Also, each base station 102 is assigned one or more carrier frequencies. Each carrier frequency is divided into eight time slots (which are labeled as time slots 0 through 7) using TDMA such that eight consecutive time slots form one TDMA frame with a duration of 4.615 milliseconds (ms). A physical channel occupies one time slot within a TDMA frame. Each active wireless communication device 104 or user is assigned one or more time slot indices for the duration of a call. User-specific data for each wireless communication device 104 is sent in the time slot(s) assigned to that wireless communication device 104 and in TDMA frames used for the traffic channels.

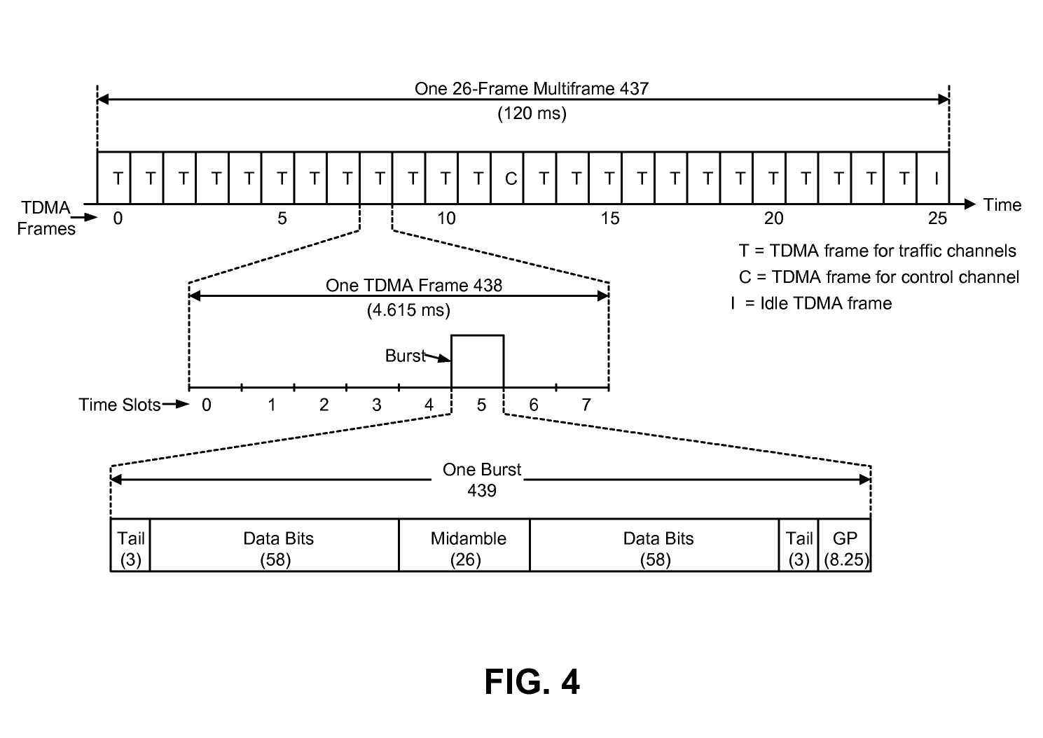

FIG. 4 shows example frame and burst formats in GSM. The timeline for transmission is divided into multiframes 437. For traffic channels used to transmit user-specific data, each multiframe 437 in this example includes 26 TDMA frames 438, which are labeled as TDMA frames 0 through 25. The traffic channels are sent in TDMA frames 0 through 11 and TDMA frames 13 through 24 of each multiframe 437. A control channel is sent in TDMA frame 12. No data is sent in idle TDMA frame 25, which is used by the wireless communication devices 104 to make measurements of signals transmitted by neighbor base stations 102.

Each time slot within a frame is also referred to as a “burst” 439 in GSM. Each burst 439 includes two tail fields, two data fields, a training sequence (or midamble) field and a guard period (GP). The number of symbols in each field is shown inside the parentheses. A burst 439 includes symbols for the tail, data, and midamble fields. No symbols are sent in the guard period. TDMA frames of a particular carrier frequency are numbered and formed in groups of 26 or 51 TDMA frames 438 called multiframes 437.

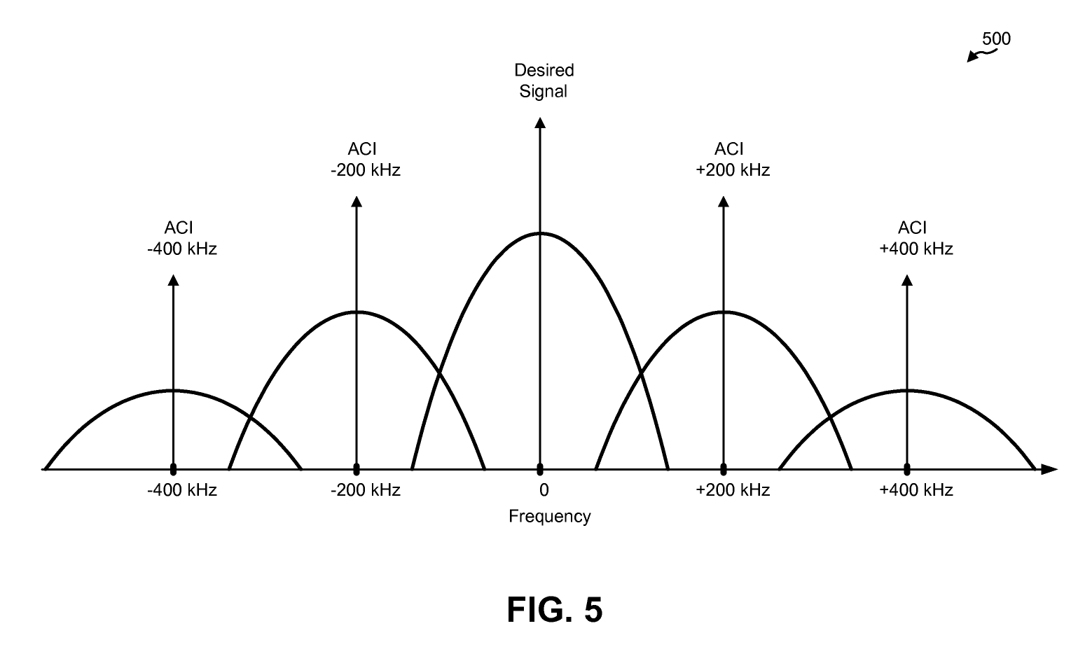

FIG. 5 shows an example spectrum 500 in a GSM system. In this example, five RF modulated signals are transmitted on five RF channels that are spaced apart by 200 kHz. The RF channel of interest is shown with a center frequency of 0 Hz. The two adjacent RF channels have center frequencies that are +200 kHz and −200 kHz from the center frequency of the desired RF channel. The next two nearest RF channels (which are referred to as blockers or non-adjacent RF channels) have center frequencies that are +400 kHz and −400 kHz from the center frequency of the desired RF channel. There may be other RF channels in the spectrum 500, which are not shown in FIG. 5 for simplicity. In GSM, an RF modulated signal is generated with a symbol rate of f_{sym}=13000/40=270.8 kilo symbols/second (ksps) and has a −3 decibel (dB) bandwidth of up to 135 kHz. The RF modulated signals on adjacent RF channels may thus overlap one another at the edges, as shown in FIG. 5.

In GSM/EDGE, frequency bursts (FB) are sent regularly by the base station 102 to allow wireless communication devices 104 to synchronize their local oscillator (LO) to the base Station 102 local oscillator (LO), using frequency offset estimation and correction. These bursts comprise a single tone, which corresponds to all “0” payload and training sequence. The all zero payload of the frequency burst is a constant frequency signal, or a single tone burst. When in power mode, the wireless communication device 104 hunts continuously for a frequency burst from a list of carriers. Upon detecting a frequency burst, the wireless communication device 104 will estimate the frequency offset relative to its nominal frequency, which is 67.7 kHz from the carrier. The wireless communication device 104 local oscillator (LO) will be corrected using this estimated frequency offset. In power up mode, the frequency offset can be as much as 19/kHz. The wireless communication device 104 will periodically wakeup to monitor the frequency burst to maintain its synchronization in standby mode. In the standby mode, the frequency offset is within ±2 kHz.

One or more modulation schemes are used in GERAN systems to communicate information such as voice, data, and/or control information. Examples of the modulation schemes may include GMSK (Gaussian Minimum Shift Keying), M-ary QAM (Quadrature Amplitude Modulation) or M-ary PSK (Phase Shift Keying), where M=2ⁿ, with n being the number of bits encoded within a symbol period for a specified modulation scheme. GMSK is a constant envelope binary modulation scheme allowing raw transmission at a maximum rate of 270.83 kilobits per second (Kbps).

General Packet Radio Service (GPRS) is a non-voice service. It allows information to be sent and received across a mobile telephone network. It supplements Circuit Switched Data (CSD) and Short Message Service (SMS). GPRS employs the same modulation schemes as GSM. GPRS allows for an entire frame (all eight time slots) to be used by a single mobile station at the same time. Thus, higher data throughput rates are achievable.

The EDGE standard uses both the GMSK modulation and 8-PSK modulation. Also, the modulation type can be changed from burst to burst. 8-PSK modulation in EDGE is a linear, 8-level phase modulation with 3π/8 rotation, while GMSK is a non-linear, Gaussian-pulse-shaped frequency modulation. However, the specific GMSK modulation used in GSM can be approximated with a linear modulation (i.e., 2-level phase modulation with a π/2 rotation). The symbol pulse of the approximated GSMK and the symbol pulse of 8-PSK are identical. The EGPRS2 standard uses GMSK, QPSK, 8-PSK, 16-QAM and 32-QAM modulations. The modulation type can be changed from burst to burst. Q-PSK, 8-PSK, 16-QAM and 32-QAM modulations in EGPRS2 are linear, 4-level, 8-level, 16-level and 32-level phase modulations with 3π/4, 3π/8, π/4, −π/4 rotation, while GMSK is a non-linear, Gaussian-pulse-shaped frequency modulation. However, the specific GMSK modulation used in GSM can be approximated with a linear modulation (i.e., 2-level phase modulation with a π/2 rotation). The symbol pulse of the approximated GSMK and the symbol pulse of 8-PSK are identical. The symbol pulse of Q-PSK, 16-QAM and 32-QAM can use spectrally narrow or wide pulse shapes.

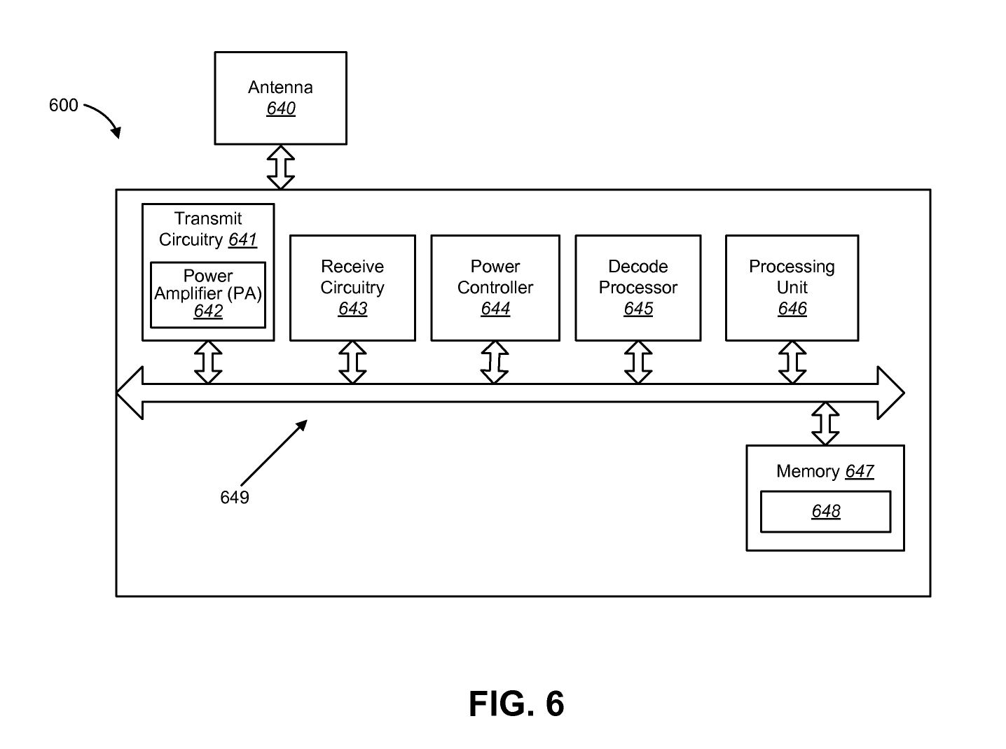

FIG. 6 illustrates an example of a wireless device 600 that includes transmit circuitry 641 (including a power amplifier 642), receive circuitry 643, a power controller 644, a decode processor 645, a processing unit 646 for use in processing signals and memory 647. The wireless device 600 may be a base station 102 or a wireless communication device 104. The transmit circuitry 641 and the receive circuitry 643 may allow transmission and reception of data, such as audio communications, between the wireless device 600 and a remote location. The transmit circuitry 641 and receive circuitry 643 may be coupled to an antenna 640.

The processing unit 646 controls operation of the wireless device 600. The processing unit 646 may also be referred to as a central processing unit (CPU). Memory 647, which may include both read-only memory (ROM) and random access memory (RAM), provides instructions and data to the processing unit 646. A portion of the memory 647 may also include non-volatile random access memory (NVRAM).

The various components of the wireless device 600 are coupled together by a bus system 649 which may include a power bus, a control signal bus, and a status signal bus in addition to a data bus. For the sake of clarity, the various busses are illustrated in FIG. 6 as the bus system 649.

The steps of the methods discussed may also be stored as instructions in the form of software or firmware located in memory 647 in a wireless device 600. These instructions may be executed by the controller/processor(s) 110 of the wireless device 600. Alternatively, or in conjunction, the steps of the methods discussed may be stored as instructions in the form of software or firmware 648 located in memory 647 in the wireless device 600. These instructions may be executed by the processing unit 646 of the wireless device 600 in FIG. 6.

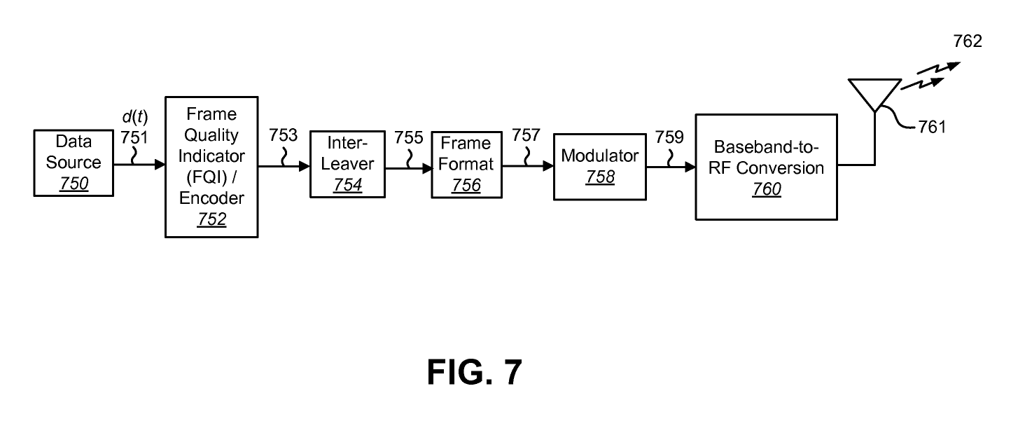

FIG. 7 illustrates an example of a transmitter structure and/or process. The transmitter structure and/or process of FIG. 7 may be implemented in a wireless device such as a wireless communication device 104 or a base station 102. The functions and components shown in FIG. 7 may be implemented by software, hardware or a combination of software and hardware. Other functions may be added to FIG. 7 in addition to or instead of the functions shown.

In FIG. 7, a data source 750 provides data d(t) 751 to a frame quality indicator (FQI)/encoder 752. The frame quality indicator (FQI)/encoder 752 may append a frame quality indicator (FQI) such as a cyclic redundancy check (CRC) to the data d(t). The frame quality indicator (FQI)/encoder 752 may further encode the data and frame quality indicator (FQI) using one or more coding schemes to provide encoded symbols 753. Each coding scheme may include one or more types of coding, e.g., convolutional coding, Turbo coding, block coding, repetition coding, other types of coding or no coding at all. Other coding schemes may include automatic repeat request (ARQ), hybrid ARQ (H-ARQ) and incremental redundancy repeat techniques. Different types of data may be encoded with different coding schemes.

An interleaver 754 interleaves the encoded data symbols 753 in time to combat fading and generates symbols 755. The interleaved symbols 755 may be mapped by a frame format block 756 to a pre-defined frame format to produce a frame 757. In an example, a frame format block 756 may specify the frame 757 as being composed of a plurality of sub-segments. Sub-segments may be any successive portions of a frame 757 along a given dimension, e.g., time, frequency, code or any other dimension. A frame 757 may be composed of a fixed plurality of such sub-segments, each sub-segment containing a portion of the total number of symbols allocated to the frame. In one example, the interleaved symbols 755 are segmented into a plurality S of sub-segments making up a frame 757.

A frame format block 756 may further specify the inclusion of, e.g., control symbols (not shown) along with the interleaved symbols 755. Such control symbols may include, e.g., power control symbols, frame format information symbols, etc.

A modulator 758 modulates the frame 757 to generate modulated data 759. Examples of modulation techniques include binary phase shift keying (BPSK) and quadrature phase shift keying (QPSK). The modulator 758 may also repeat a sequence of modulated data.

A baseband-to-radio-frequency (RF) conversion block 760 may convert the modulated data 759 to RF signals for transmission via an antenna 761 as signal 762 over a wireless communication link to one or more wireless device receivers.

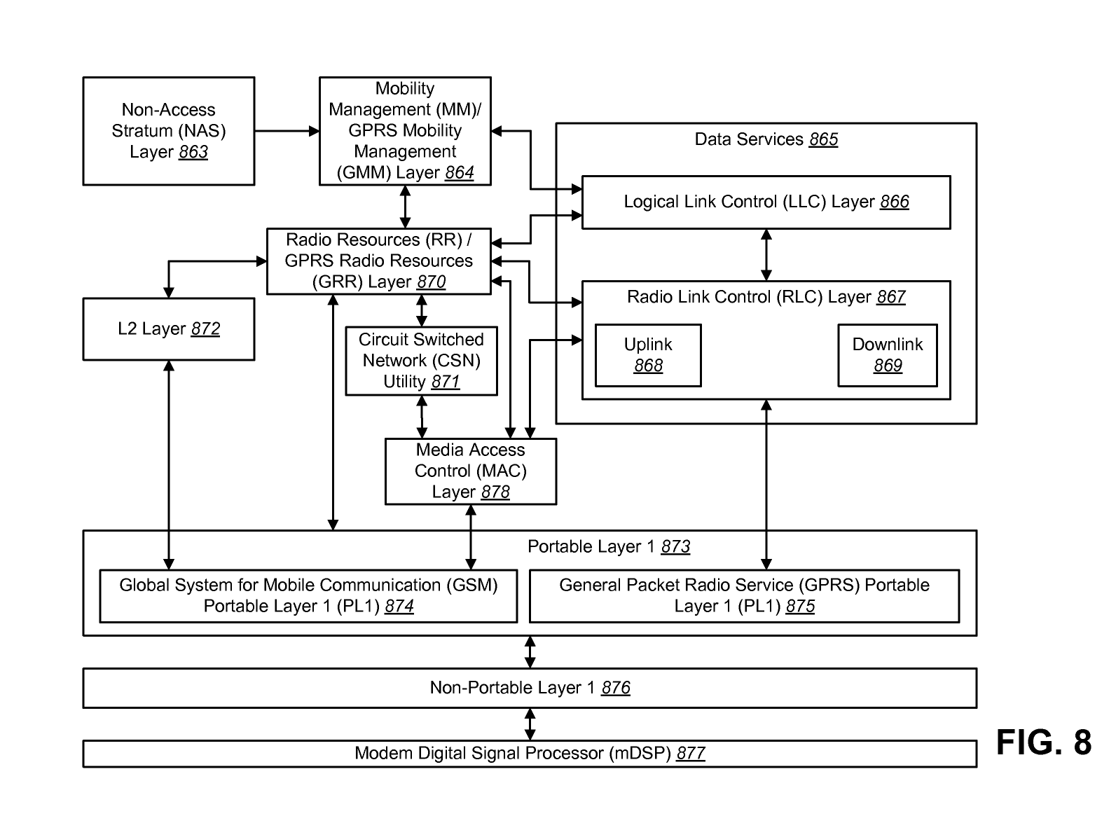

FIG. 8 is a block diagram illustrating some of the elements of the GERAN stack that are used to support voice services over adaptive multi-user channels on one slot (VAMOS) in some embodiments of the present invention. The non-access stratum (NAS) layer 863 may include the voice services over adaptive multi-user channels on one slot (VAMOS) radio capability classmark. The non-access stratum (NAS) layer 863 may send information to the mobility management (MM)/GPRS mobility management (GMM) layer 864. The mobility management (MM)/GPRS mobility management (GMM) layer 864 may communicate with a logical link control (LLC) layer 866 in data services 865. The mobility management (MM)/GPRS mobility management (GMM) layer 864 may also communicate with a radio resources (RR)/GPRS radio resources (GRR) layer 870.

The data services 865 may also include a radio link control (RLC) layer 867 for uplink 868 and downlink 869 communications. The radio link control (RLC) layer 867 may communicate with the logical link control (LLC) layer 866 and the radio resources (RR)/GPRS radio resources (GRR) layer 870. The logical link control (LLC) layer 866 may also communicate with the radio resources (RR)/GPRS radio resources (GRR) layer 870. The radio link control (RLC) layer 867 may also communicate with a General Packet Radio Service (GPRS) Portable Layer 1 (PL1) 875 of the portable layer 1 873. The portable layer 1 873 may include the General Packet Radio Service (GPRS) Portable Layer 1 (PL1) 875 and the Global Systems for Mobile Communication (GSM) Portable Layer 1 (PL1) 874. The radio resources (RR)/GPRS radio resources (GRR) layer 870 may communicate directly with the portable layer 1 873.

The radio resources (RR)/GPRS radio resources (GRR) layer 870 may also communicate with the Global Systems for Mobile Communication (GSM) Portable Layer 1 (PL1) 874 via an L2 layer 872. The radio resources (RR)/GPRS radio resources (GRR) layer 870 may communicate with a media access control (MAC) layer 878 via a Circuit Switched Network (CSN) Utility 871. The radio resources (RR)/GPRS radio resources (GRR) layer 870 may also communicate directly with the media access control (MAC) layer 878. The media access control (MAC) layer 878 may communicate with both the radio link control (RLC) layer 867 and the General Packet Radio Service (GPRS) Portable Layer 1 (PL1) 875. The portable layer 1 873 may communicate with a non-portable layer 1 876. The non-portable layer 1 876 may then communicate with a modem digital signal processor (mDSP) 877.

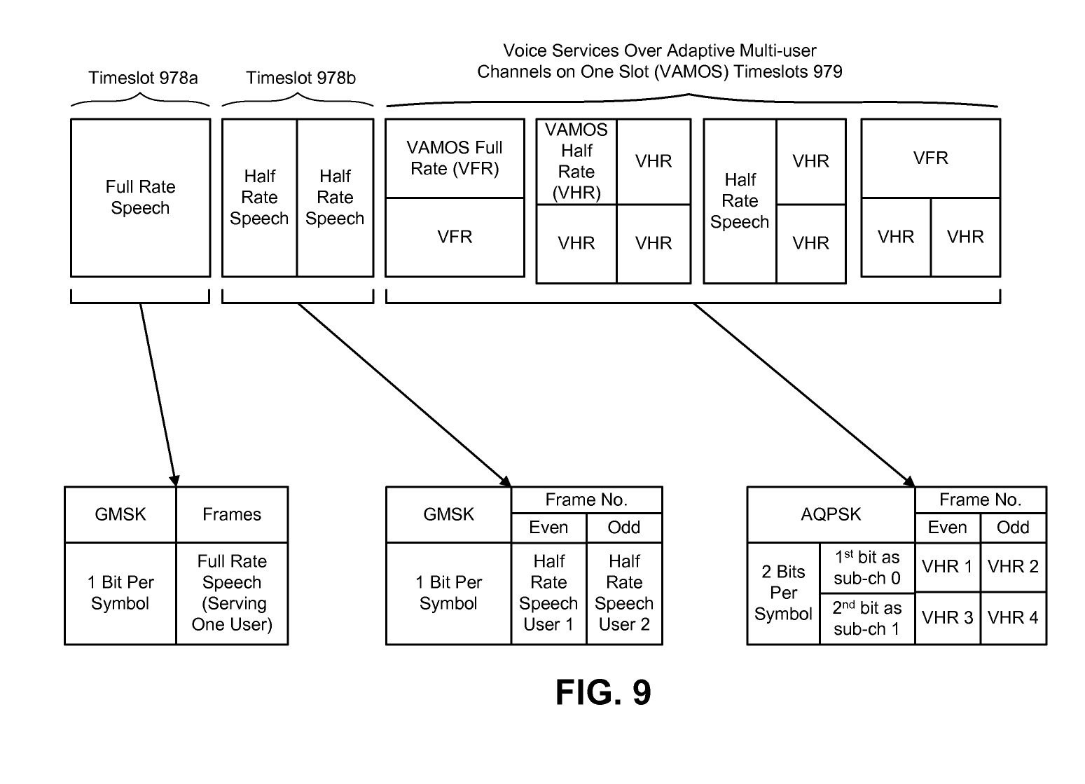

FIG. 9 is a block diagram illustrating how, in some embodiments, different numbers of users may be served in timeslots 979 using voice services over adaptive multi-user channels on one slot (VAMOS). In a non-VAMOS slot 978a, one full rate speech (FR) wireless communication device 104 may be served using Gaussian minimum shift keying (GMSK). Or, in a non-VAMOS slot 978b, two half rate speech (HR) wireless communication devices 104 may be served using Gaussian minimum shift keying (GMSK). In voice services over adaptive multi-user channels on one slot (VAMOS), two wireless communication devices 104 may be paired using adaptive quadrature phase shift keying (AQPSK) on the downlink 869 while using Gaussian minimum shift keying (GMSK) unchanged on the uplink 868. Thus, two full rate speech (FR) and four half rate speech (HR) wireless communication devices 104 can be served on one timeslot 979. Voice services over adaptive multi-user channels on one slot (VAMOS) are compatible with legacy wireless communication devices 104 and can make use of well the established downlink advanced receiver performance (DARP) feature. As used herein, legacy wireless communication devices 104 refers to downlink advanced receiver performance (DARP) phones and pre-DARP phones. In some cases, using voice services over adaptive multi-user channels on one slot (VAMOS) may double the capacity or achieve the same capacity using half the spectrum when compared to the standard Global Systems for Mobile Communication (GSM) framework.

The voice services over adaptive multi-user channels on one slot (VAMOS) feature was introduced in 3GPP GERAN Release 9 standards in order to improve the spectrum efficiency for Circuit Switched (CS) connections. Voice services over adaptive multi-user channels on one slot (VAMOS) may only be applicable to the Circuit Switched (CS) voice service and not the Packet Switched (PS) data service.

Voice services over adaptive multi-user channels on one slot (VAMOS) may serve two wireless communication devices 104 simultaneously on the same physical resources (i.e., on the same timeslot and the same absolute radio-frequency channel number (ARFCN)) in the circuit switched mode both in the downlink 869 and in the uplink 868 in one embodiment. Hence, a basic physical channel capable of voice services over adaptive multi-user channels on one slot (VAMOS) may support up to four transmit channel (TCH)/half rate (HR) channels along with their associated control channels (i.e., the fast associated control channel (FACCH) and the slow associated control channel (SACCH/T) (half rate)). Voice services over adaptive multi-user channels on one slot (VAMOS) may be used for voice service configurations for one timeslot 979 by network control for three, four or five wireless communication devices 104 without telling each wireless communication device 104 involved.

The symbols shown are a simplified version of the resource usage. A legacy full rate speech (FR) may use the entire symbol, which only has 1 bit, and all of the frame number (FN). Hence, one unit of resource (i.e., one timeslot 979) may serve one wireless communication device 104 at any time. However, using the existing half rate speech (HR) service, based on Gaussian minimum shift keying (GMSK) modulation, the unit of resource may be divided on the frame number (FN) dimension. Thus, two wireless communication devices 104 may be served from one transmit channel (TCH) resource (classified by an even frame number (FN) and an odd frame number (FN)). When the radio frequency (RF) conditions are good enough to support half rate speech (HR), capacity gain may be achieved. In the voice services over adaptive multi-user channels on one slot (VAMOS) mode, which is based on adaptive quadrature phase shift keying (AQPSK) modulation, two bits/symbol may provide another dimension (i.e., the number of bits per symbol on top of the previous half rate speech (HR) scheme). Thus, a base station 102 using voice services over adaptive multi-user channels on one slot (VAMOS) may support up to four half rate speech (HR) voice services over adaptive multi-user channels on one slot (VAMOS) calls in one transmit channel (TCH) resource (i.e., voice services over adaptive multi-user channels on one slot (VAMOS) timeslots 979) when the radio frequency (RF) conditions are good enough to support adaptive quadrature phase shift keying (AQPSK) with half rate speech (HR) codecs, including Adaptive Multi-Rate (AMR) half rate speech (HR).

The variety of Circuit Switched (CS) services for a legacy system is shown by the first two blocks (timeslots 978a-b), which can support up to two wireless communication devices 104. By using voice services over adaptive multi-user channels on one slot (VAMOS), additional wireless communication devices 104 per timeslot 979 may be used (e.g., up to four total). The channel organization for the transmit channel (TCH), the fast associated control channel (FACCH) and the slow associated control channel (SACCH/T) (half rate) in voice services over adaptive multi-user channels on one slot (VAMOS) mode may be compatible with the legacy mode. A voice services over adaptive multi-user channels on one slot (VAMOS) level 1 wireless communication device 104 does not have any differences as far as channel organization is concerned. Voice services over adaptive multi-user channels on one slot (VAMOS) level 1 is a downlink advanced receiver performance (DARP) based solution. Voice services over adaptive multi-user channels on one slot (VAMOS) level 2 can enable further performance improvement with the knowledge of both training sequence codes (TSCs) in the pair and further slow associated control channel (SACCH) channel shift to maximize performance.

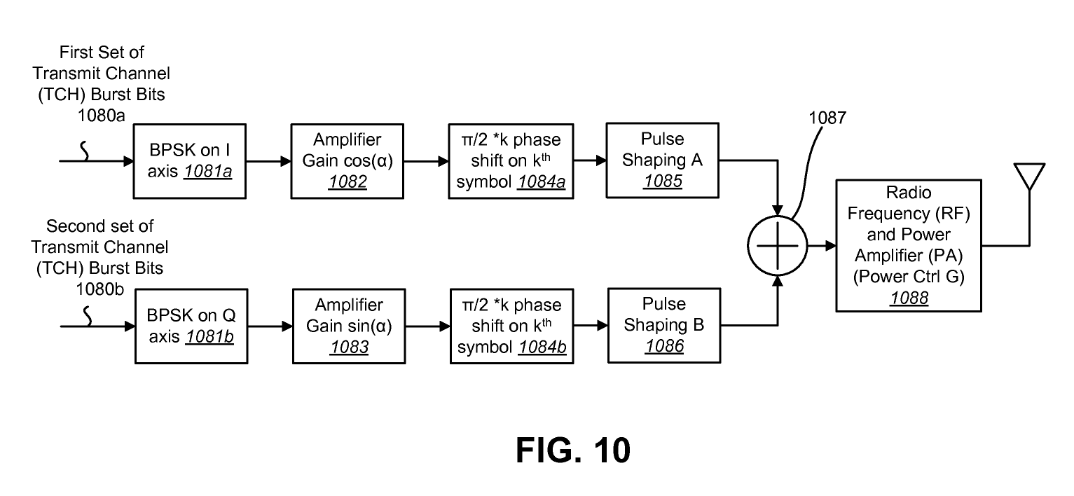

FIG. 10 is a block diagram illustrating one embodiment of the voice services over adaptive multi-user channels on one slot (VAMOS) downlink physical layer functionality of a base station 102. A pair of corresponding bits from the transmit channels (TCHs) and the associated control channels in a voice services over adaptive multi-user channels on one slot (VAMOS) pair may be mapped on to an adaptive quadrature phase shift keying (AQPSK) modulation symbol with the assigned training sequence codes (TSCs). The first set of transmit channel (TCH) burst bits 1080a may correspond to a first wireless communication device 104 and the second set of transmit channel (TCH) burst bits 1080b may correspond to a second wireless communication device 104.

The first set of transmit channel (TCH) burst bits 1080a may be passed through a binary phase shift keying (BPSK) 1081a on the inphase (I) axis, an amplifier 1082 with a gain of cos(α), a phase shift 1084a of

$$\frac{π}{2} * k$$

on the kth symbol and pulse shaping A 1085. The second set of transmit channel (TCH) burst bits 1080b may be passed through a binary phase shift keying (BPSK) 108 lb on the quadrature (Q) axis, an amplifier 1083 with a gain of sin(α), a phase shift 1084b of

$$\frac{π}{2} * k$$

on the kth symbol and pulse shaping B 1086. The first set of transmit channel (TCH) burst bits 1080a and the second set of transmit channel (TCH) burst bits 1080b may then be combined using an adder 1087 and passed through an RF modulator and a power amplifier 1088 before being transmitted by the base station 102.

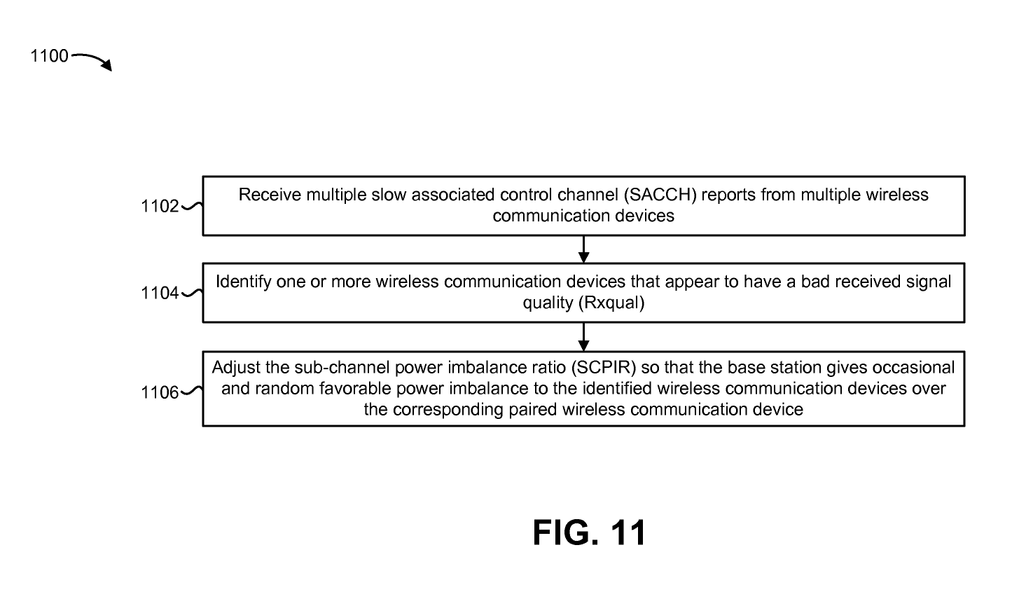

FIG. 11 is a flow diagram of a method 1100 for preventing dropped voice calls. The method 1100 may be performed by a base station 102 or other access-point type component in one embodiment of the present invention. The base station 102 may receive 1102 multiple slow associated control channel (SACCH) reports from multiple wireless communication devices 104. Some of the wireless communication devices 104 may be legacy downlink advanced receiver performance (DARP) phones. Thus, these wireless communication devices 104 may be based on single antenna interference cancellation (SAIC) and can be used to decode voice services over adaptive multi-user channels on one slot (VAMOS) adaptive quadrature phase shift keying (AQPSK) modulated RF signals.

The wireless communication devices 104 may need to do time tracking and frequency tracking This is because there is no perfect system in a live network. Time tracking and frequency tracking may result in a constant interference presented by adaptive quadrature phase shift keying (AQPSK). If adaptive quadrature phase shift keying (AQPSK) is constantly used, the wireless communication devices 104 may track the wrong time and frequency.

The base station 102 may identify 1104 one or more wireless communication devices 104 that appear to have a bad received signal quality (Rxqual). The base station 102 may then adjust 1106 the sub-channel power imbalance ratio (SCPIR) so that the base station 102 gives occasional and random favorable power imbalance to the indentified wireless communication devices 104 over the corresponding paired wireless communication device 104. This adjustment may range from slight to extreme. In addition, the adjustment can be performed on a dynamic basis. For example, in some embodiments, the adjustment may result in the corresponding paired wireless communication device 104 missing one burst.

In other embodiments, additional bursts may be missed (e.g., ranging from 2-20). Preferably, however, the point is to miss as few bursts as possible so as not to degrade voice quality to unacceptable levels (i.e., voice traffic becomes unintelligible to users or surpasses network thresholds). The adaptive scheme may stop the sub-channel power imbalance ratio (SCPIR) from progressing towards causing further damaging bursts. A call may be dropped if the slow associated control channel (SACCH) has been lost for a predefined number of bursts or amount of time that may be set by the network. If a call is dropped, the system may declare a radio link failure.

As mentioned above, adjusting 1106 the sub-channel power imbalance ratio (SCPIR) so that the base station 102 gives occasional and random favorable power imbalance to identified wireless communication devices 104 can be advantageous. For example, this adjustment may give Gaussian minimum shift keying (GMSK) or very favorable adaptive quadrature phase shift keying (AQPSK) to identified wireless communication devices 104. Doing so can prevent voice calls from being terminated and/or dropped thereby enabling continuation of phone calls.

Thus, with very little compromise on speech quality, the network can keep a voice call alive that would likely otherwise be dropped. This is a problem faced by billions of wireless communication devices 104 in the live network. Embodiments of the present invention, such as method 1100 provide an adaptive, practical and effective solution to help legacy downlink advanced receiver performance (DARP) wireless communication devices 104 work in voice services over adaptive multi-user channels on one slot (VAMOS) mode. The corresponding paired wireless communication device 104 (i.e., the wireless communication device 104 with the perceived better received signal quality (Rxqual)) may miss one burst in a few seconds. This may not cause any issues for the user experience. This is because missing one burst in a few seconds does not significantly degrade the perceived voice quality.

A wireless communication device 104 may be capable of discerning the changes in adaptive quadrature phase shift keying (AQPSK)/sub-channel power imbalance ratio (SCPIR) implemented by a base station 102. The wireless communication device 104 may generate slow associated control channel (SACCH) reports. Generated slow associated control channel (SACCH) reports may be transmitted to a base station 102. In response, the base station 102 may adjust the sub-channel power imbalance ratio (SCPIR) to the wireless communication device 104. The wireless communication device 104 may perform adaptive burst processing according to the discerned changes to obtain the best performance in terms of the bit error rate (BER) and the frame error rate (FER). In some examples, the adaptation can be such that the BER and/or FER are scaled or ranged to provide acceptable voice quality for end users. These can be modified as desired and/or required by system performance. In other examples, the adaptive processing can yield BER and/or FER that prevents a voice call from being unintelligible by end users and/or from being dropped.

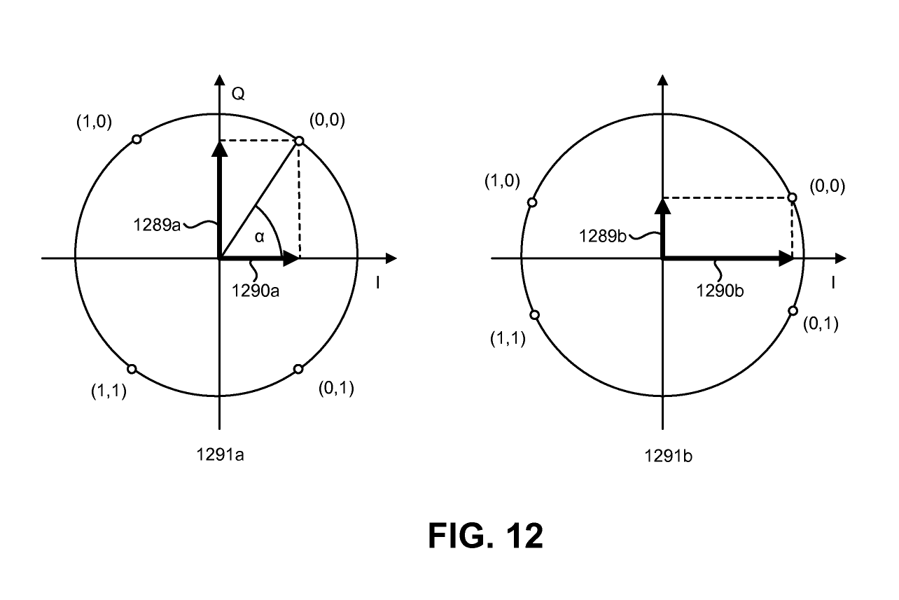

FIG. 12 illustrates two adaptive quadrature phase shift keying (AQPSK) constellations 1291a-b for use in one embodiment of the present invention. Other adaptive quadrature phase shift keying (AQPSK) constellation 1291 may also be used. Each wireless communication device 104 may be given a binary phase shift keying (BPSK) constellation with progressive 90 degree rotation on a symbol basis to keep the signal compatible with the existing Gaussian minimum shift keying (GMSK) modulation so that legacy wireless communication devices 104 may also be used in voice over adaptive multi-user channels on one slot (VAMOS) mode.

The two binary phase shift keying (BPSK) constellations of paired wireless communication devices 104 may be 90 degrees apart. A binary phase shift keying (BPSK) constellation 1289a of a first wireless communication device 104 and a binary phase shift keying (BPSK) constellation 1290a of a second wireless communication device 104 are shown in the first adaptive quadrature phase shift keying (AQPSK) constellation 1291a. Each of the sub-channels may have different power levels, as is illustrated by the binary phase shift keying (BPSK) constellation 1289b corresponding to a first wireless communication device 104 and the binary phase shift keying (BPSK) constellation 1290b corresponding to a second wireless communication device 104 of the second adaptive quadrature phase shift keying (AQPSK) constellation 1291b. The base station 102 may adjust these sub-channel power imbalances (i.e., the sub-channel power imbalance ratio (SCPIR)) such that a wireless communication device 104 with a bad received signal quality (Rxqual) may receive an occasional and random favorable power imbalance.

The value of the sub-channel power imbalance ratio (SCPIR) is given by SCPIR=20 log₁₀ (tan α)) and is in decibels (dB). Table 1 gives some angles a and their corresponding sub-channel power imbalance ratios (SCPIR).

TABLE 1

| Angle α (deg) | R = tan(α) | SCPIR 20 × logR (dB) |
|---|---|---|
| 0 | 0.00 | −∞ |
| 22.5 | 0.41 | −7.65552 |
| 45 | 1.00 | 0 |
| 67.5 | 2.41 | 7.655508 |
| 90 | ∞ | ∞ |

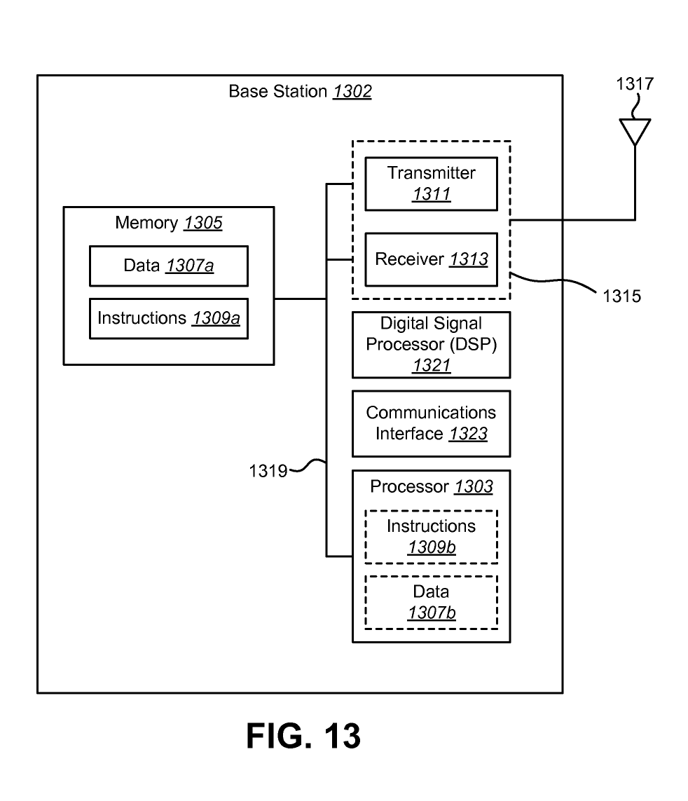

FIG. 13 illustrates certain components that may be included within a base station 1302. A base station 1302 may also be referred to as, and may include some or all of the functionality of, an access point, a broadcast transmitter, a NodeB, an evolved NodeB, etc. The base station 1302 includes a processor 1303. The processor 1303 may be a general purpose single- or multi-chip microprocessor (e.g., an ARM), a special purpose microprocessor (e.g., a digital signal processor (DSP)), a microcontroller, a programmable gate array, etc. The processor 1303 may be referred to as a central processing unit (CPU). Although just a single processor 1303 is shown in the base station 1302 of FIG. 13, in an alternative configuration, a combination of processors (e.g., an ARM and DSP) could be used.

The base station 1302 also includes memory 1305. The memory 1305 may be any electronic component capable of storing electronic information. The memory 1305 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof

Data 1307a and instructions 1309a may be stored in the memory 1305. The instructions 1309a may be executable by the processor 1303 to implement the methods disclosed herein. Executing the instructions 1309a may involve the use of the data 1307a that is stored in the memory 1305. When the processor 1303 executes the instructions 1309a, various portions of the instructions 1309b may be loaded onto the processor 1303, and various pieces of data 1307b may be loaded onto the processor 1303.

The base station 1302 may also include a transmitter 1311 and a receiver 1313 to allow transmission and reception of signals to and from the base station 1302. The transmitter 1311 and receiver 1313 may be collectively referred to as a transceiver 1315. An antenna 1317 may be electrically coupled to the transceiver 1315. The base station 1302 may also include (not shown) multiple transmitters, multiple receivers, multiple transceivers and/or additional antennas.

The base station 1302 may include a digital signal processor (DSP) 1321. The base station 1302 may also include a communications interface 1323. The communications interface 1323 may allow a user to interact with the base station 1302.

The various components of the base station 1302 may be coupled together by one or more buses, which may include a power bus, a control signal bus, a status signal bus, a data bus, etc. For the sake of clarity, the various buses are illustrated in FIG. 13 as a bus system 1319.

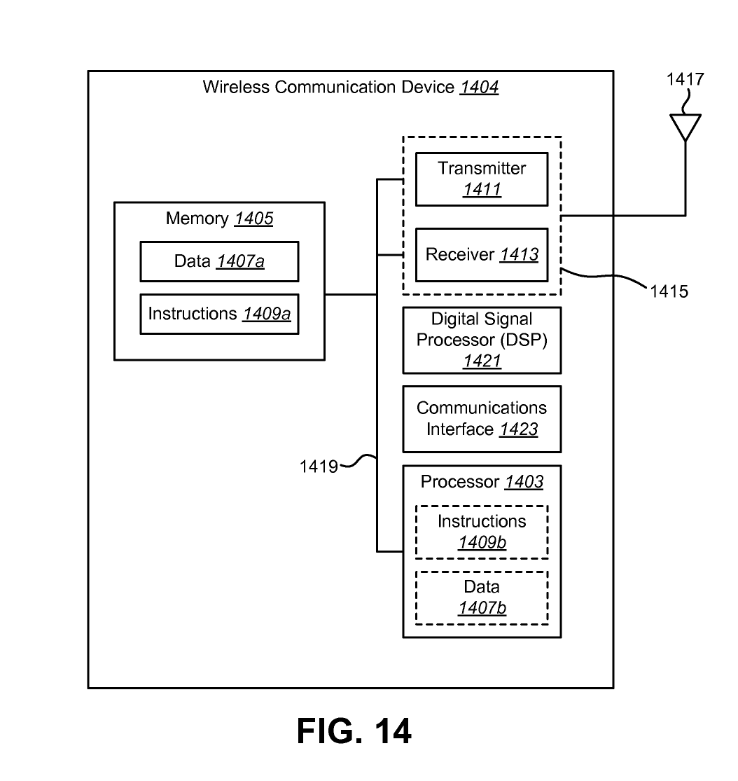

FIG. 14 illustrates certain components that may be included within a wireless communication device 1404. The wireless communication device 1404 may be an access terminal, a mobile station, a user equipment (UE), etc. The wireless communication device 1404 includes a processor 1403. The processor 1403 may be a general purpose single- or multi-chip microprocessor (e.g., an ARM), a special purpose microprocessor (e.g., a digital signal processor (DSP)), a microcontroller, a programmable gate array, etc. The processor 1403 may be referred to as a central processing unit (CPU). Although just a single processor 1403 is shown in the wireless communication device 1404 of FIG. 14, in an alternative configuration, a combination of processors (e.g., an ARM and DSP) could be used.

The wireless communication device 1404 also includes memory 1405. The memory 1405 may be any electronic component capable of storing electronic information. The memory 1405 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1407a and instructions 1409a may be stored in the memory 1405. The instructions 1409a may be executable by the processor 1403 to implement the methods disclosed herein. Executing the instructions 1409a may involve the use of the data 1407a that is stored in the memory 1405. When the processor 1403 executes the instructions 1409, various portions of the instructions 1409b may be loaded onto the processor 1403, and various pieces of data 1407b may be loaded onto the processor 1403.

The wireless communication device 1404 may also include a transmitter 1411 and a receiver 1413 to allow transmission and reception of signals to and from the wireless communication device 1404 via an antenna 1417. The transmitter 1411 and receiver 1413 may be collectively referred to as a transceiver 1415. The wireless communication device 1404 may also include (not shown) multiple transmitters, multiple antennas, multiple receivers and/or multiple transceivers.

The wireless communication device 1404 may include a digital signal processor (DSP) 1421. The wireless communication device 1404 may also include a communications interface 1423. The communications interface 1423 may allow a user to interact with the wireless communication device 1404.

The various components of the wireless communication device 1404 may be coupled together by one or more buses, which may include a power bus, a control signal bus, a status signal bus, a data bus, etc. For the sake of clarity, the various buses are illustrated in FIG. 14 as a bus system 1419.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral or external to a processor can be in electronic communication with the processor (e.g., direct or indirect electrical communication).

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 11, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for preventing bad user experience and dropped voice calls, wherein the method is performed by an access point, the method comprising:
identifying a first wireless communication device having a poor received signal using multiple reports received from multiple wireless communication devices; and
adjusting a sub-channel power imbalance ratio so that the access point gives a favorable power imbalance to the first wireless communication device over a second wireless communication device, wherein the second wireless communication device is paired with the first wireless communication device, and wherein adjusting the sub-channel power imbalance ratio prevents a voice call by the first wireless communication device from being dropped that would otherwise be dropped.

2. The method of claim 1, wherein the access point is configured to use voice services over adaptive multi-user channels on one slot.

3. The method of claim 2, wherein the voice services over adaptive multi-user channels on one slot enables the access point to support up to four transmit channel/half rate channels along with their associated control channels in one slot.

4. The method of claim 2, wherein the voice services over adaptive multi-user channels on one slot uses adaptive quadrature phase shift keying.

5. The method of claim 1, wherein the reports are slow associated control channel reports.

6. The method of claim 1, wherein the first wireless communication device is a legacy wireless communication device.

7. The method of claim 1, wherein the first wireless communication device is a downlink advanced receiver performance wireless communication device.

8. The method of claim 1, wherein the first wireless communication device is allowed to operate in voice services over adaptive multi-user channels on one slot mode.

9. The method of claim 1, wherein the second wireless communication device misses one burst during the adjustment of the sub-channel power imbalance ratio.

10. The method of claim 1, wherein the access point giving favorable power imbalance to the first wireless communication device comprises giving occasional and random favorable power imbalance to the first wireless communication device.

11. The method of claim 1, wherein adjusting a sub-channel power imbalance ratio gives Gaussian minimum shift keying to the first wireless communication device.

12. The method of claim 1, wherein adjusting a sub-channel power imbalance ratio gives favorable adaptive quadrature shift keying to the first wireless communication device.

13. An apparatus for preventing bad user experience and dropped voice calls, comprising:
a processor;
memory in electronic communication with the processor; and
instructions stored in the memory, the instructions being executable by the processor to:
identify a first wireless communication device having a poor received signal using multiple reports received from multiple wireless communication devices; and
adjust a sub-channel power imbalance ratio so that the apparatus gives a favorable power imbalance to the first wireless communication device over a second wireless communication device, wherein the second wireless communication device is paired with the first wireless communication device, and wherein adjusting the sub-channel power imbalance ratio prevents a voice call by the first wireless communication device from being dropped that would otherwise be dropped.

14. The apparatus of claim 13, wherein the apparatus is a base station, and wherein the apparatus is configured to use voice services over adaptive multi-user channels on one slot.

15. The apparatus of claim 14, wherein the voice services over adaptive multi-user channels on one slot enables the apparatus to support up to four transmit channel/half rate channels along with their associated control channels in one slot.

16. The apparatus of claim 14, wherein the voice services over adaptive multi-user channels on one slot uses adaptive quadrature phase shift keying.

17. The apparatus of claim 13, wherein the reports are slow associated control channel reports.

18. The apparatus of claim 13, wherein the first wireless communication device is a legacy wireless communication device.

19. The apparatus of claim 13, wherein the first wireless communication device is a downlink advanced receiver performance wireless communication device.

20. The apparatus of claim 13, wherein the first wireless communication device operates in voice services over adaptive multi-user channels on one slot mode.

21. The apparatus of claim 13, wherein the second wireless communication device misses one burst during the adjustment of the sub-channel power imbalance ratio.

22. The apparatus of claim 13, wherein the apparatus giving favorable power imbalance to the first wireless communication device comprises giving occasional and random favorable power imbalance to the first wireless communication device.

23. The apparatus of claim 13, wherein adjusting a sub-channel power imbalance ratio gives Gaussian minimum shift keying to the first wireless communication device.

24. The apparatus of claim 13, wherein adjusting a sub-channel power imbalance ratio gives favorable adaptive quadrature shift keying to the first wireless communication device.

25. A wireless device for preventing bad user experience dropped voice calls, comprising:
means for identifying a first wireless communication device having a poor received signal using multiple reports received from multiple wireless communication devices; and
means for adjusting a sub-channel power imbalance ratio so that the wireless device gives a favorable power imbalance to the first wireless communication device over a second wireless communication device, wherein the second wireless communication device is paired with the first wireless communication device, and wherein adjusting the sub-channel power imbalance ratio prevents a voice call by the first wireless communication device from being dropped that would otherwise be dropped.

26. The wireless device of claim 25, wherein the wireless device is a base station, and wherein the wireless device is configured to use voice services over adaptive multi-user channels on one slot.

27. The wireless device of claim 26, wherein the voice services over adaptive multi-user channels on one slot enables the wireless device to support up to four transmit channel/half rate channels along with their associated control channels in one slot.

28. The wireless device of claim 26, wherein the voice services over adaptive multi-user channels on one slot uses adaptive quadrature phase shift keying.

29. A computer-program product for preventing bad user experience and dropped voice calls, the computer-program product comprising a non-transitory computer-readable medium having instructions thereon, the instructions comprising:
code for causing an access point to identify a first wireless communication device having a poor received signal using multiple reports received from multiple wireless communication devices; and
code for causing the access point to adjust a sub-channel power imbalance ratio so that the base station gives a favorable power imbalance to the first wireless communication device over a second wireless communication device, wherein the second wireless communication device is paired with the first wireless communication device, and wherein adjusting the sub-channel power imbalance ratio prevents a voice call by the first wireless communication device from being dropped that would otherwise be dropped.

30. The computer-program product of claim 29, wherein the access point is a base station, and wherein the base station is using voice services over adaptive multi-user channels on one slot.

31. The computer-program product of claim 30, wherein the voice services over adaptive multi-user channels on one slot allows the base station to support up to four transmit channel/half rate channels along with their associated control channels in one slot.

32. The computer-program product of claim 30, wherein the voice services over adaptive multi-user channels on one slot uses adaptive quadrature phase shift keying.

33. An apparatus configured for preventing bad user experience and dropped voice calls, the apparatus comprising:
a processor;
memory in electronic communication with the processor; and
instructions stored in the memory, the instructions being executable by the processor to:
discern changes in adaptive quadrature phase shift keying/sub-channel power imbalance ratio implemented by a base station; and
perform adaptive burst processing according to the changes.

34. The apparatus of claim 33, wherein the apparatus is a wireless communication device.

35. The apparatus of claim 33, wherein the adaptive burst processing provides a bit error rate that prevents a voice call by from being dropped.

36. The apparatus of claim 33, wherein the adaptive burst processing provides a frame error rate that prevents a voice call by from being dropped.

37. A wireless device for preventing bad user experience and dropped voice calls, comprising:
means for discerning changes in adaptive quadrature phase shift keying/sub-channel power imbalance ratio implemented by a base station; and
means for performing adaptive burst processing according to the changes.

38. The wireless device of claim 37, wherein the wireless device is a wireless communication device.

39. The wireless device of claim 38, wherein the adaptive burst processing provides a bit error rate that prevents a voice call by from being dropped.

40. The wireless device of claim 39, wherein the adaptive burst processing provides a frame error rate that prevents a voice call by from being dropped.
